(19) United States
(12) Patent Application Publication
(10) Pub. No.: US 2026/0127620 A1
(43) Pub. Date: May 7, 2026

(54) Intelligent Apparatus for Next-GEN Carbon Credits Platform Leveraging Synthetic Data Token Generation Powered by Responsible AI

(71) Applicant: Bank of America Corporation, Charlotte, NC (US)

(72) Inventors: Gowri Sundar Suriyanarayanan, Chennai (IN); Maneesh Kumar Sethia, Hyderabad (IN); Madala Rajasekhar, Hyderabad (IN)

(73) Assignee: Bank of America Corporation, Charlotte, NC (US)

(21) Appl. No.: 18/938,887

(22) Filed: Nov. 6, 2024

(51) Int. Cl. G06Q 30/018; G06N 5/022; G06Q 20/38; G06Q 30/0207; G06Q 30/0601

(52) U.S. Cl. CPC G06Q 30/018; G06N 5/022; G06Q 20/389; G06Q 30/0222; G06Q 30/0635; G06Q 2220/00

(57) ABSTRACT

Intelligent methods, processes, and systems are disclosed for generating synthetic eco-crypto tokens for carbon credits and may include the steps of identifying the amount of carbon credits saved for a product or service purchased by a customer by using data centric artificial intelligence (AI) working with trained data sets. The trained data sets may be loaded to knowledge graphs and a unique green reward identification for a customer may be combined to then generate a new synthetic data which may be used to generate an eco-crypto token. Responsible AI may be used to generate the eco-crypto tokens in a safe, trustworthy, and ethical fashion for use in other transactions for products and services.

### TECHNICAL FIELD

The present disclosure relates to the fields of environmental sustainability, artificial intelligence, synthetic data generation, and blockchain-based carbon credit reward systems. Specifically, it relates to an intelligent platform and process that utilizes responsible artificial intelligence (AI) for generating synthetic data tokens tied to carbon credits, facilitating secure, resource-efficient transactions in carbon credit marketplaces as disclosed herein.

### BACKGROUND

At present, there is no carbon credits payment gateway that supports seamless transactions or allows the purchase of environment sustainable products, which are rewarded in return for eco-friendly choices. The generation of unique tokens for such systems heavily relies on traditional crypto-mining or minting processes, which are resource-intensive and environmentally damaging.

Moreover, earned and existing carbon credits cannot be utilized across different platforms due to interoperability issues. This limits the growth of carbon credits systems and discourages adoption. Additionally, the need for a secure, responsible method of generating, managing, and validating carbon credit tokens across platforms remains unmet.

### SUMMARY

In light of the foregoing background, the following presents a simplified summary of the present disclosure in order to provide a basic understanding of various aspects of the disclosure. This summary is not limiting with respect to the exemplary aspects of the inventions described herein and is not an extensive overview of the disclosure. It is not intended to identify key or critical elements of the disclosure or to delineate the scope of the disclosure. Instead, as would be understood by a personal of ordinary skill in the art, the following summary merely presents some concepts of the disclosure in a simplified form as a prelude to the more detailed description provided below.

In one aspect of the disclosure, a process for generating synthetic eco-crypto tokens for carbon credits is disclosed in accordance with one or more aspects described herein and may include the steps of identifying an energy-efficient transaction or an energy-efficient service by collecting relevant data using a data-centric artificial intelligence (AI) module, analyzing an energy savings associated with each product or service and calculating corresponding carbon credits, storing information on energy savings and carbon credits in a knowledge graph in which the knowledge graph may be trained using a hypergraph neural network to encode high-order data correlations, generating an eco-crypto token based on analyzed data provided by the data-centric AI module and knowledge graph, onboarding a customer onto an eco-crypto rewards platform and generating a unique eco-crypto token based on customer data and a timestamp, collecting energy-saving data using a data-centric AI module and training a knowledge graph to reflect energy efficiency metrics, encrypting the eco-crypto token with homomorphic encryption to ensure secure transaction processing, validating the transaction or service using a responsible AI module based on data from the knowledge graph, and recording the generated eco-crypto token in a rewards ledger.

In some examples, energy-saving data from industries and products may be collected using an AI data collector integrated into the data-centric AI module, and this data may be used to continuously train the knowledge graph. In other examples, the responsible AI module may ensure that eco-token generation may be carried out in a resource-efficient and ethical manner, preventing unnecessary energy consumption. In some aspects, the process may further include generating dynamic smart contracts to automatically adjust the eco-crypto token in the rewards ledger according to a customer purchase history. In one example, the generated eco-crypto token may be unique to each customer and may only be decoded by the eco-crypto rewards ledger to ensure secure and accurate carbon credit transactions. In yet another example, a dynamic smart contract engine may be used to generate a dynamic smart contract configured to manage validation and claim processing of the eco-crypto token. In still another example, homomorphic encryption of an eco-crypto ID for the customer may be used to secure processing of the customer data. In some examples, the responsible AI module may be configured to monitor and ensure resource-efficient eco-token generation and compliance with ethical standards, thereby minimizing unnecessary energy consumption.

In some examples, a customer cryptocurrency balance may be verified prior to initiating the transaction or service to ensure that the customer has sufficient eco-tokens to complete the transaction or service. In yet another example, the service may be designing, developing, testing, updating, or maintaining software. In one example, the knowledge graph may be trained continuously using a Hypergraph Neural Network (HGNN) framework to adapt to new energy-saving data, enabling dynamic and accurate allocation of carbon credits. As disclosed herein, the generated eco-crypto token may be reflective of a customer contribution to reducing carbon emissions. In some examples, the transaction may be a purchase of an eco-friendly product. In other examples, the eco-token may be used for other crypto-currency transactions.

In another aspect of the disclosure, a process of purchasing eco-friendly products using an eco-friendly cryptocurrency-based system may include the steps of determining whether a customer is onboarded on a platform that supports eco-friendly product purchases, allowing the customer to purchase eco-friendly products using a cryptocurrency token specific to the platform, completing a cryptocurrency transaction for the purchased eco-friendly product, associating the purchase with an amount of carbon savings linked to the eco-friendly product purchased, adding a corresponding reward value to a reward ledger based on a cryptocurrency value used for purchasing carbon-saving products, and updating the reward ledger.

In some examples, the steps may further include receiving customer data for a customer to be onboarded onto the platform, verifying a customer identity through a Know Your Customer (KYC) verification; wherein the KYC process checks the customer data for compliance with identity verification regulations, onboarding the customer if the KYC verification is successful, or returning the customer to a verification process if the KYC verification is unsuccessful, generating an eco-crypto token for the customer via an eco-crypto token generator upon successful onboarding of the customer, recording the generated eco-crypto token in a carbon crypto rewards ledger, wherein the carbon crypto rewards ledger maintains a record of customer eco-crypto tokens and associated rewards, and completing the customer onboarding process, wherein the customer is successfully integrated into the platform after the eco-crypto token generation and logging processes.

In other examples, the eco-friendly products available for purchase are filtered based on a predefined sustainability criteria, such as carbon footprint reduction, biodegradability, or renewable resource usage. In one example, a calculated carbon savings score for each eco-friendly product based on its lifecycle carbon impact may be displayed to the customer. In yet another example, the process may further include generating a dynamic smart contract comprising instructions for validation and claiming of the customer associated rewards.

In another aspect of the disclosure, a system for generating synthetic data tokens in a carbon credits platform may include a data-centric AI module configured to identify and analyze energy-efficient purchases and calculate corresponding carbon credits, a knowledge graph configured to store information on energy savings and carbon credits associated with products, wherein the knowledge graph may be trained using a hypergraph neural network to encode high-order data correlations, a synthetic data token generator configured to generate a unique synthetic data token based on data provided by the data-centric AI module and knowledge graph, a customer eco crypto ID that may be encrypted using homomorphic encryption, allowing encrypted data operations without requiring decryption, a responsible AI module configured to validate transactions and ensure ethical, secure, and resource-efficient processing of carbon credit token generation, a rewards ledger configured to store synthetic data tokens linked to the customer's eco crypto ID and to record transactions and token usage.

In some examples, the data-centric AI module includes a tiny AI data collector that collects energy-saving data from industries and products, which may be used to train the knowledge graph. In other examples, the synthetic data token generator produces a unique token that can only be decoded by the eco crypto rewards platform, ensuring secure transactions. In some examples, the system may further include a dynamic smart contract engine configured to govern the validation and claim process for synthetic data tokens, allowing token points to be debited from the rewards ledger based on predefined rules. In one example, the homomorphic encryption allows operations on the encrypted eco crypto ID to ensure that user data may be secure throughout the transaction without requiring decryption. In still other examples, the responsible AI module may be configured to monitor resource usage during token generation and ensure compliance with ethical standards in processing carbon credit data. In one example, the knowledge graph employs a Hypergraph Neural Network (HGNN) to continuously learn and adapt to new energy-saving data, enabling more accurate carbon credits allocation over time.

In another aspect of the disclosure, a carbon credits rewards system as disclosed herein may include synthetic data tokens representative of carbon savings and generated through a combination of an eco-crypto identification, knowledge graph metrics, and responsible artificial intelligence, in which the system may be configured to transfer data across multiple platforms, and a rewards ledger may be configured to dynamically update based on a transaction or a service and an issuance of carbon credit rewards. In certain examples, the transaction may be a purchase of an eco-friendly product. In other examples, the service may be designing, developing, testing, updating, and/or maintaining software.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts a sample, functional, architectural-block diagram showing sample interactions, steps, functions, and components of a process, method, system, and apparatus for synthetic green carbon eco-crypto token generation in accordance with one or more aspects described herein.

FIG. 2 depicts a sample, functional, architectural-block diagram showing sample interactions, steps, functions, and components of a process, method, system, and apparatus for customer onboarding in a next generation carbon credits platform leveraging synthetic data eco-crypto token generation powered by responsible artificial intelligence in accordance with one or more aspects described herein.

FIGS. 3A and 3B depict a sample, functional, architectural-block diagram showing sample interactions, steps, functions, and components of a process, method, system, and apparatus for a carbon rewards claiming platform associated with a next generation carbon credits platform leveraging synthetic data eco-crypto token generation powered by responsible artificial intelligence in accordance with one or more aspects described herein.

FIG. 4 depicts a flow chart for customer purchasing from an eco-product purchase platform and customer onboarding in a next generation carbon credits platform leveraging synthetic data eco-crypto token generation powered by responsible artificial intelligence in accordance with one or more aspects described herein.

FIG. 5 depicts a flow chart for smart contract generation in a carbon rewards claiming platform in a next generation carbon credits platform leveraging synthetic data eco-crypto token generation powered by responsible artificial intelligence in accordance with one or more aspects described herein.

### DETAILED DESCRIPTION

In the following description of the various embodiments to accomplish the foregoing, reference is made to the accompanying drawings, which form a part hereof, and in which is shown by way of illustration, various embodiments in which the disclosure may be practiced. It is to be understood that other embodiments may be utilized, and structural and functional modifications may be made. It is noted that various connections between elements are discussed in the following description. It is noted that these connections are general and, unless specified otherwise, may be direct or indirect, wired, or wireless, and that the specification is not intended to be limiting in this respect.

As used throughout this disclosure, any number of computers, machines, or the like can include one or more general-purpose, customized, configured, special-purpose, virtual, physical, and/or network-accessible devices such as: administrative computers, application servers, clients, cloud devices, clusters, compliance watchers, computing devices, computing platforms, computer machines, controlled computers, controlling computers, desktop computers, distributed systems, enterprise computers, instances, laptop devices, monitors or monitoring systems, nodes, notebook computers, personal computers, portable electronic devices, portals (internal or external), servers, smart devices, streaming servers, tablets, web servers, and/or workstations, which may have one or more application specific integrated circuits (ASICs), microprocessors, cores, executors, etc., for executing, accessing, controlling, implementing, etc., various software, computer-executable instructions, data, modules, processes, routines, or the like as discussed below.

References to computers, machines, or the like as in the examples above are used interchangeably in this specification and are not considered limiting or exclusive to any type(s) of electrical device(s), or component(s), or the like. Instead, references in this disclosure to computers, machines, devices, or the like are to be interpreted broadly as understood by skilled artisans. Further, as used in this specification, computers, machines, devices, or the like also include all hardware and components typically contained therein such as, for example, ASICs, processors, executors, cores, etc., display(s) and/or input interfaces/devices, network interfaces, communication buses, or the like, and memories or the like, which can include various sectors, locations, structures, or other electrical elements or components, software, computer-executable instructions, data, modules, processes, routines, etc. Other specific or general components, machines, or the like are not depicted in the interest of brevity and would be understood readily by a person of skill in the art.

As used throughout this disclosure, software, computer-executable instructions, machine-readable data, modules, processes, routines, or the like can include one or more: active-learning, algorithms, algorithm-driven, alarms, alerts, applications, application program interfaces (APIs), artificial intelligence, approvals, asymmetric encryption (including public/private keys), attachments, big data, blockchains, blocks, CRON functionality, daemons, databases, datasets, datastores, DeFi functionality, drivers, data structures, deep learning modules (e.g., knowledge graphs, NLP, LSTM, GAN, etc.), distributed ledgers, distributed-ledger blockchains, distributed-ledger hash chains dynamic rule engines, engines, emails, extraction functionality, file systems or distributed file systems, firmware, governance rules, graphical user interfaces (GUI or UI), images, instructions, interactions, Java jar files, Java Virtual Machines (JVMs), juggler schedulers and supervisors, layers, load balancers, load functionality, logic, machine learning (supervised, semi-supervised, unsupervised, or natural language processing), metadata, middleware, modules, namespaces, objects, operating systems, optimization modules, platforms, plugins, processes, protocols, programs, rejections, routes, routines, rule deployment modules, security, scripts, tables, tools, transactions, transformation functionality, user actions, user interface codes, utilities, web application firewalls (WAFs), web servers, web sites, etc.

As used throughout this disclosure, computer “networks,” topologies, or the like can include one or more local area networks (LANs), wide area networks (WANs), the Internet, clouds, hosts, wired networks, wireless networks, digital subscriber line (DSL) networks, frame relay networks, asynchronous transfer mode (ATM) networks, virtual private networks (VPN), or any direct or indirect combinations of the same. They may also have separate interfaces for internal network communications, external network communications, and management communications. Virtual IP addresses (VIPs) may be coupled to each if desired. Networks also include associated equipment and components such as access points, adapters, buses, ethernet adaptors (physical and wireless), firewalls, hubs, modems, routers, and/or switches located inside the network, on its periphery, and/or elsewhere, and software, computer-executable instructions, data, modules, processes, routines, or the like executing on the foregoing. Network(s) may utilize any transport that supports HTTPS or any other type of suitable communication, transmission, and/or other packet-based protocol. Decentralized networks (e.g., DeFi networks), in particular, are included in the foregoing and are protected by the information-security aspects of this disclosure.

The foregoing software, computer-executable instructions, machine-readable data, data, engine, modules, plugins, processes, programs, routines, or the like can be on tangible computer-readable memory (local, in network-attached storage, be directly and/or indirectly accessible by network, removable, remote, cloud-based, cloud-accessible, etc.), can be stored in volatile or non-volatile memory, and can operate autonomously, on-demand, on a schedule, spontaneously, proactively, and/or reactively, and can be stored together or distributed across computers, machines, or the like (e.g., in a decentralized network that may include a consortium of networks, entities, institutions, etc.) including memory and other components thereof. Some or all the foregoing may additionally and/or alternatively be stored similarly and/or in a distributed manner in the network accessible storage/distributed data/datastores/databases/big data/blockchains/distributed-ledger blockchains/distributed ledger hash chains/hash chain network/hashed mesh, etc.

Digital and cryptocurrency transactions in a blockchain may be executed on a third-party-transaction device and recorded in blocks through a process that involves several steps. This process ensures the integrity, transparency, and security of transactions on the blockchain, which is the underlying technology of digital transactions, cryptocurrencies like Bitcoin, Ethereum, and many others such as an eco-crypto token or cryptocurrency for carbon credits as disclosed herein. A customer or user may initiate a transaction by sending cryptocurrency from their wallet to another person's wallet address. This transaction includes the amount of cryptocurrency being sent, the sender's and recipient's/counterpart's wallet addresses, and typically a transaction cost. The transaction is signed with the sender's private key, serving as a digital signature to verify the authenticity of the transaction and that the sender has the authority to transfer the funds. Once signed, the transaction is broadcasted to the cryptocurrency network, where it is propagated to various nodes (i.e., computers and/or servers in the network). These nodes temporarily hold the transaction in their memory pool (mempool), awaiting confirmation and inclusion in a block. Nodes, or in the case of an eco-friendly cryptocurrency, Bitcoin, and many other cryptocurrencies, specialized nodes called miners, verify the transaction. This verification process includes checking the digital signature against the sender's public key and ensuring the sender has sufficient balance to cover the transaction and costs. Verified transactions are collected by miners and grouped together to form a new block. In cryptocurrencies that use Proof of Work, miners compete to solve a complex mathematical puzzle related to the new block. The first miner to solve the puzzle gets the right to add the new block to the blockchain. Other cryptocurrencies may use different consensus mechanisms, such as Proof of Stake, which selects validators in proportion to their quantity of holdings in the cryptocurrency to create new blocks, or Delegated Proof of Stake, which involves election of delegate validators.

Once a block is completed and verified through the validation mechanism, it is added to the blockchain. This new block includes a reference to the hash of the previous block, creating a secure, unbreakable chain of blocks. The addition of the new block to the blockchain is broadcasted across the network. Nodes update their copies of the blockchain to include the new block. This update confirms the transactions contained within the block across the entire network. With the block added to the blockchain, the transactions within it are considered confirmed. This process typically requires a number of additional blocks to be added after the initial block, to ensure irreversibility-a security measure against double spending. In Proof of Work (PoW) systems, the miner who successfully adds a block to the blockchain receives a reward in the form of newly minted cryptocurrency (e.g., an eco-crypto token as disclosed herein) and transaction costs from the transactions within the block. This process ensures that cryptocurrency transactions are securely and transparently recorded on the blockchain, making it extremely difficult to alter historical data or conduct fraudulent transactions without the consensus of the network.

An objective of the methods and systems disclosed herein is to provide a carbon credit payment gateway or platform that may utilize an intelligent procedure to identify the amount of carbon credits a customer or individual may save by purchasing an eco-friendly product or service by using data centric AI to work with trained data sets. The trained data sets may be loaded to the knowledge graphs and a unique customer green reward identification (ID) may be combined to generate a new synthetic data which can be used as a carbon synthetic data token (e.g., eco-crypto token). The process and method disclosed herein may also use responsible AI which will take care of the token generation in a safe, trustworthy and ethical fashion.

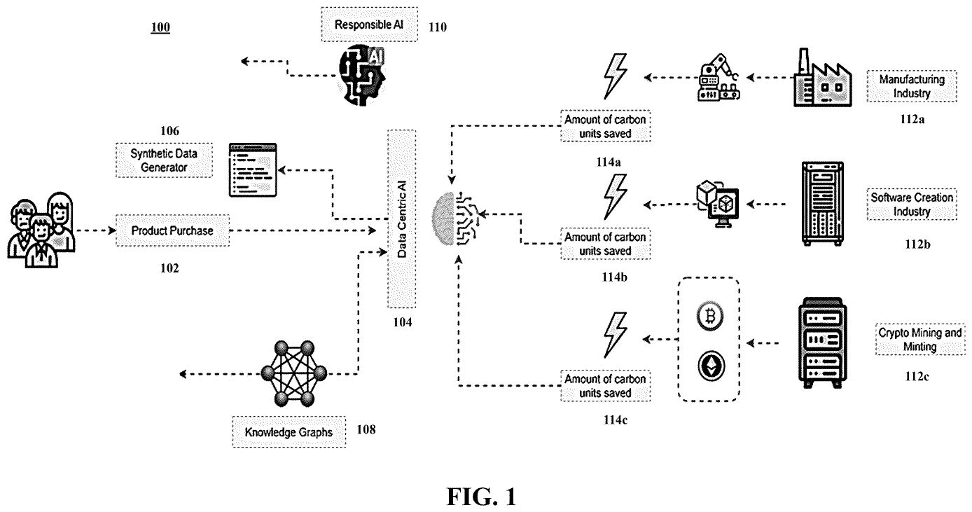

By way of non-limiting disclosure, FIG. 1 depicts platform 100 for synthetic green carbon eco-cryptocurrency generation using tracked carbon emissions across various industries in accordance with one or more aspects described herein. As previously discussed, a payment gateway/platform and related process 100 may be established to facilitate and support the purchase of eco-friendly products or services 102. The architecture of platform 100 is centered on a data-centric AI module 104 focusing on secure, efficient data handling, validation, and adherence to ethical standards. Platform 100 and related processes also integrate other components such as synthetic data generator 106 configured to synthetic data related to the eco-friendly transaction, customer unique ID data validation, knowledge graphs 108, and a responsible AI module 110 to facilitate eco-friendly transactions seamlessly and securely.

The data centric AI module 104 and the knowledge graphs 108 may utilize data from, for example, the manufacturing industry 112a that measures and utilizes carbon units saved in production of goods and materials and the related data is transmitted at 114a to the data centric AI module 104, the software creation industry 112b that includes benefits from and integrates carbon savings from efficient creation of software and the related data is transmitted at 114b to the data centric AI module 104, and energy saved by the crypto mining and minting industry 112c and the related data is transmitted at 114c to the data centric AI module 104. Carbon emissions, specifically from crypto mining, are often energy-intensive. Energy data and related carbon savings may be collected across various industries not depicted in FIG. 1 (e.g., transportation industry, health industry, etc.).

The data centric AI module 104 may focus on training knowledge graphs 108 ensure the collected data (e.g., the amount of energy being saved by a particular industry) clearly conveys what the knowledge graphs 104 must learn. The data centric AI module 104 may utilizes synthetic data and may feed into a knowledge graph model (e.g., knowledge graphs 108) to process and validate carbon rewards data. Knowledge graphs 108 (i.e., relationship based mapping) are the pretrained data sets which have information about the amount of percentage of credits that may be given for the products or services being purchased. Knowledge graphs 108 may store patterns for reward metrics, product capacities, and data model mappings. Knowledge graphs 108 may be customized to use the hypergraph neural networks (HGNN) framework for data representation learning, which may encode high-order data correlation in a hypergraph structure. Again, the data centric AI module 104 will train the knowledge graphs 108 based on the latest information collected to make sure the rewards are credited according to the energy efficiency and carbon savings.

Synthetic data token generator 106 facilitates the generating of a unique synthetic data eco-crypto token based upon the information collected from unique customer eco-crypto ID and metrics from the data centric AI module 104, and knowledge graphs 108. As disclosed herein, the synthetic data eco-crypto token will be unique may only be decoded by the eco-crypto rewards system. A customer must first be onboarded to the eco-crypto rewards platform 100. The unique eco-crypto token will be generated based on the customer's unique information and the timestamp the customer was onboarded. When the customer initiates a purchase 102 their unique eco-crypto token may be protected with homomorphic encryption via platform 100. The amount of carbon credits will be tied to the transaction and sent to the responsible AI module 110 for validation. Based upon the information collected from knowledge graphs 108 and the incoming data, platform 100 identifies the carbon credits percentage and transmits the related metrics to the synthetic data generator 106 to generate an eco-crypto token that may be saved to a rewards ledger. The claiming process may use a smart contract which has set of rules and debit the token points based on the next purchase. Additionally, customer data may be encrypted with homomorphic encryption to eliminate the need to conduct decryption. As also disclosed herein, dynamic smart contracts may be generated using digital ethical rules including a set of instructions to validate and claim the synthetic data eco-crypto tokens. Smart contracts and the responsible AI module 110 ensure data sets are functioning as expected. Smart contracts establish rules that continually monitor data within the knowledge graphs 108. If discrepancies or errors are identified, responsible AI 110 flags them and alerts the system. The Data centric AI module 104 receives these alerts, corrects the data, and sends the corrected data back to the responsible AI module 110 for re-validation. The data centric AI module 104 will learn from the responsible AI module 110. For example, based on the results and data verified by the responsible AI module 110, or in the case of identifying a mistake or an error in the data, the responsible AI will modify its digital ethical rules accordingly. This iterative process allows the AI algorithms to learn and improve continuously.

As disclosed herein, platform 100 emphasizes a data-centric approach, with responsible AI enforcing ethical standards and knowledge graphs aiding in data organization. The platform and related processes integrate carbon-saving metrics from various industries, generates crypto credits (e.g., eco-crypto tokens) based on these metrics, and provides secure, verified data handling through synthetic data and homomorphic encryption. The advantages of the architecture of platform 100 include interoperability as the platform and process can easily integrate with various systems, such as eco-transport or cryptocurrency services, using dynamic APIs. Responsible AI 110 ensures fairness and adherence to digital ethics, reducing the risk of bias. Responsible AI 110 uses several guiding principles for maintaining proper resource usage to include accountability via algorithms and correlations that may be open for inspection. Impartiality using equitable checks for consistent application. Resiliency through protocols that may be reinforced with human oversight. Transparency so that users may understand data, output, and decisions of platform 100. Enhanced security to protect against physical and digital risks. And governance through clear organizational roles for data responsibility. Responsible AI 110 ensures data is accurate and up to standards and interacts continuously with the knowledge graphs 108.

The data centric AI framework of platform 100 provides a robust and modular solution that can be applied across industries, ensuring secure, efficient, and responsible data processing. The platform's flexibility makes it ideal for a wide range of eco-friendly applications, supporting seamless integration and rewarding sustainability efforts.

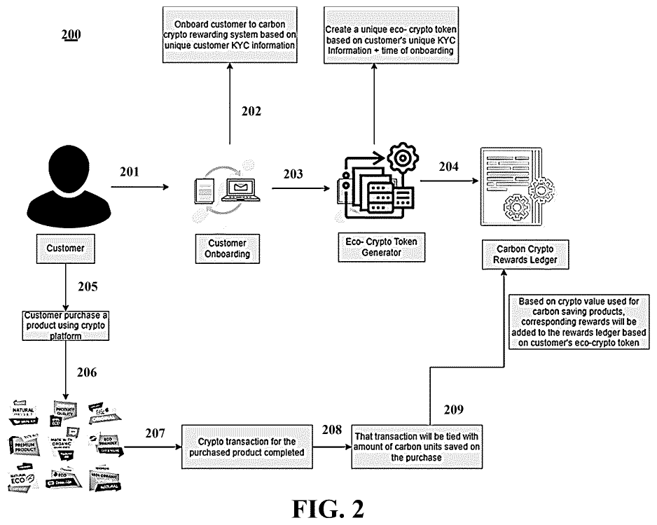

FIG. 2 depicts a sample, functional, architectural-block diagram showing process 200 for customer onboarding in a next generation carbon credit platform leveraging synthetic data token generation powered by responsible artificial intelligence in accordance with one or more aspects described herein.

At step 201, a customer initiates the purchase of a product or service via the eco-crypto platform and the onboarding process initiates. A secure unique-identification (ID) for the customer may be uniquely identified and generated inside the platform on may facilitate customer onboarding.

At step 202, the customer may be onboarded to the carbon credit platform (e.g., carbon crypto rewarding system) based upon verification of the unique-ID and customer KYC information and determination that compliance requirements are met.

Various types of information may be collected about the customer and may be customized to generate the unique ID. Unique IDs may be generated via dynamic algorithm mapping to secure a customer's information and generated Unique ID. For example, via the dynamic algorithm mapping, a unique ID may be generated via an AES (Advanced Encryption Standard) algorithm. The next time, the unique ID may be generated via an MTS (Mahalanobis-Taguchi System) algorithm. On another day, the unique ID may be generated via a SHA-2 algorithm (Secure Hash Algorithm 2), and so on. The Dynamic algorithm mapping may shuffle algorithms such that an individual will be incapable of what algorithm is being used and how a related eco-crypto token is generated.

At step 203, a unique eco-crypto token for the customer may be generated using the customer's unique ID and KYC information at the time of onboarding. The generated eco-crypto tokens themselves may also be environmentally friendly and designed to have minimal carbon impact.

At step 204 the generated eco-crypto token for the customer may be added to a carbon crypto rewards ledger in a similar manner previously described above. In some instances, the carbon crypto rewards ledger may be decentralized.

At step 205, the customer initiates a purchase of a product or service via the platform using the generated eco-crypto tokens.

At step 206, retrieval of the generated eco-crypto tokens facilitate the purchase of the desired product or service. As discussed above, carbon emissions may be minimized during eco-crypto token generation, and a carbon offset mechanism may be created and incorporated in the platform to counteract the emissions produced by the customer's eco-crypto activities. The carbon offsets may be issued as credits, which may be visible to the customer as a means to promote additional environmental responsibility.

At step 207, the crypto transaction for the purchased product or service is completed.

At step 208, the eco-crypto tokens, along with the carbon offset information related to the purchase, are securely stored in the customer's crypto wallet for ongoing verification and tracking.

At step 209, the platform may generate an eco-crypto wallet emissions profile, detailing the emissions associated with the eco-crypto activities and how they are offset by the eco-crypto tokens and related carbon credits. Based upon the eco-crypto wallet emissions profile, an emissions score for the customer may be calculated. This score may represent the environmental impact of the customer's eco-crypto activities. The emissions score data may be added to the carbon crypto rewards ledger based upon the purchase and eco-crypto token data.

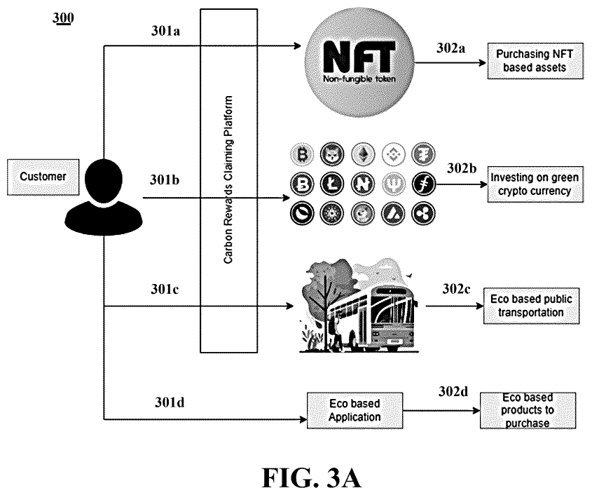

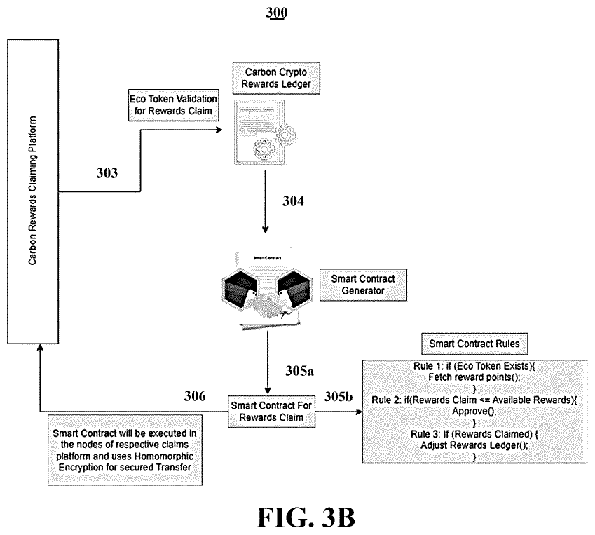

FIGS. 3A and 3B depict a carbon rewards claiming platform and process 300 as described herein.

At step 301, the process begins with a customer interacting with the carbon rewards claiming platform. As discussed above, the process and platform will validate a customer's unique ID and determine if it is unique or not upon onboarding. As described above, the platform enables the customer to claim carbon rewards through eco-friendly activities or purchases at step 302.

For example, a customer may initiate a transaction, via the carbon rewards claiming platform at step 301a, and purchase NFT-based assets that are environmentally conscious contributing to the eco-rewards system at step 302a.

In another example, a customer may initiate a transaction, via the carbon rewards claiming platform at step 301b, and invest in green cryptocurrency at step 302b, which may be designed to have a lower carbon footprint compared to traditional cryptocurrencies and related investments.

In yet another example, a customer may initiate a transaction, via the carbon rewards claiming platform at step 301c, to participate in eco-friendly public transportation that may also contribute to the customer's carbon rewards at step 302c.

As previously discussed, a customer may initiate a purchase at step 301d for a product or service in which the customer is provided with options to purchase eco-based products, further encouraging sustainable choices and generating additional rewards at step 302d, and encouraging further sustainable choices and generating additional rewards.

The process emphasizes environmentally friendly activities, with each action (e.g., NFT purchase, green crypto investment, public transportation, and eco-product purchase) feeding into a reward system aimed at incentivizing sustainable behavior. The carbon rewards claiming platform acts as the hub through which the customer's actions are tracked and rewarded based on their environmental impact.

As shown in FIG. 3B, the carbon rewards claiming platform 300 may generate a validated eco-crypto token at step 303 for the related transaction and may be added at step 304 to the carbon crypto reward ledger.

At step 304, the data from the carbon crypto rewards ledger may be transmitted to a smart contract generator.

At step 305a, a smart contract for the rewards claims may be generated according to the smart contract rules of step 305b. The smart contract may be defined by a set of digital rules framed according to the specific situation or transaction. For example, if a customer is verifying a balance of eco-crypto tokens required by a particular transaction, a corresponding smart contract may be generated to validate if the customer is legitimate or not. If the customer is legitimate and verified, the customer account may then be verified for an appropriate balance. The smart contract rules at step 305b may also change according to how a customer is going to retrieve and apply a particular reward or how the rewards will be claimed.

At step 306, the smart contract is executed in the nodes of the respective carbon rewards claiming platform. In some examples, homomorphic encryption may be used for the secure transmission of the smart contract. Homomorphic encryption is a form of encryption that allows computations to be performed on the encrypted data of the customer and related smart contract without first having to decrypt it. The resulting computations may remain in an encrypted form which, when decrypted, result in an output that is identical to that produced had the operations been performed on the unencrypted data. Homomorphic encryption may be used to preserve the privacy of customer data and related smart contract information to prevent attacks that would enable an attacker to access that data while it is being processed.

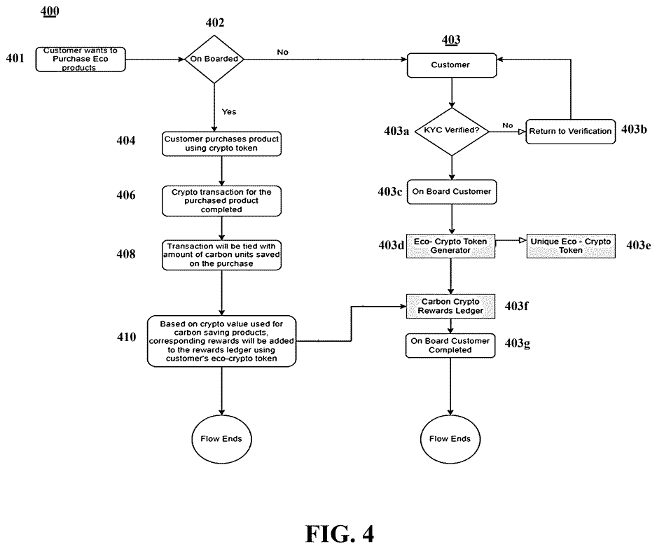

FIG. 4 depicts a flow chart for process 400 of purchasing eco-products using a next generation carbon credits platform in accordance with one or more aspects described herein.

At step 401, the process starts when a customer initiates a purchase of eco-friendly products.

At step 402, the customer is verified via onboarding process 403.

At step 403a, the customer is verified via KYC protocols. If KYC verification fails, the customer is returned to the initiation of the verification process 403 at step 403b. After verification, the customer is officially onboarded at step 403c.

At step 403d, customer unique ID and related data is transmitted to an eco-crypto token generator. At step 403e, the eco-crypto token generator, using the unique customer ID and related data, generates an eco-crypto token for the onboarded customer for in the transaction or purchase of the eco-product.

At step 403f, the customer's data related to the transaction is recorded in a carbon crypto rewards ledger via a blockchain and the customer onboarding is completed at step 403g .

At step 404, the customer purchases an eco-friendly product using their eco-crypto token.

At step 406, the transaction is processed and completed for the purchased product.

At step 408, the transaction is linked with the amount of carbon units saved as a result of the purchase.

At step 410, based upon the eco-crypto value used for purchasing carbon-saving products or services, corresponding rewards are added to the carbon crypto rewards ledger using the customer's eco-crypto token and purchase data completing and ending process 400.

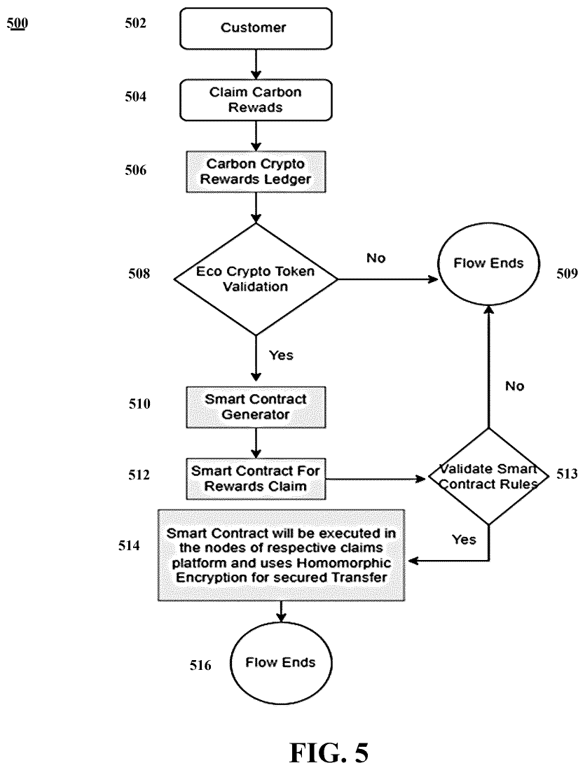

FIG. 5 depicts a flow chart for process 500 of generating a smart contract in a carbon rewards claiming platform in accordance with one or more aspects described herein.

At step 502, the process begins with a customer initiating a transaction.

At step 504, the customer initiates a request to claim carbon rewards.

At step 506, the claim is registered in a carbon crypto rewards ledger.

At step 508, the platform checks the validity of the eco-crypto token associated with the rewards claim. If the eco-crypto token is valid, the process proceeds to step 510.

At step 509, if it is determined that the eco-crypto token is invalid, the process ends.

At step 510, a smart contract generator creates a smart contract for the reward claim in accordance with the smart contract rules at step 513 and as discussed above. If the smart contract rules are invalid, the process ends at step 509.

At step 514, and the smart contract rules are valid, the validated smart contract will be executed on the respective carbon credit claiming platform. As described above, the carbon credits claiming platform may employ homomorphic encryption for secure transfer of data.

At step 516, the process is completed.

One or more aspects discussed herein may be embodied in computer-usable or readable data and/or computer-executable instructions, such as in one or more plugins, executed by one or more computers or other devices as described herein. Generally, plugin include routines, programs, objects, components, data structures, and the like that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. As will be appreciated by one of skill in the art, the functionality of the plugin may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a system, and/or a computer program product.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A process for generating synthetic eco-crypto tokens for carbon credits, comprising:
identifying an energy-efficient transaction or an energy-efficient service by collecting relevant data using a data-centric artificial intelligence (AI) module;
analyzing an energy savings associated with each product or service and calculating corresponding carbon credits;
storing information on energy savings and carbon credits in a knowledge graph, wherein the knowledge graph is trained using a hypergraph neural network to encode high-order data correlations;
generating an eco-crypto token based on analyzed data provided by the data-centric AI module and the knowledge graph;
onboarding a customer onto an eco-crypto rewards platform and generating a unique eco-crypto token based on customer data and a timestamp;
collecting energy-saving data using a-the data-centric AI module and training the knowledge graph to reflect energy efficiency metrics;
encrypting the eco-crypto token with homomorphic encryption to ensure secure transaction processing;
validating the transaction or service using a responsible AI module based on data from the knowledge graph;
providing, via a platform that supports eco-friendly product or service purchases, the purchased product or service to the customer; and
recording the generated eco-crypto token in a rewards ledger.

2. The process of claim 1 further comprising:
collecting energy-saving data from industries and products using an AI data collector integrated into the data-centric AI module, where this data is used to continuously train the knowledge graph.

3. The process of claim, 1 wherein the responsible AI module ensures that eco-crypto token generation is carried out in a resource-efficient and ethical manner, preventing unnecessary energy consumption.

4. The process of claim 1, further comprising generating dynamic smart contracts to automatically adjust the eco-crypto token in the rewards ledger according to a purchase history.

5. The process of claim 1, wherein the eco-crypto token generated is unique to each customer and can only be decoded by the eco-crypto rewards ledger to ensure secure and accurate carbon credit transactions.

6. The process of claim 1, further comprising the step of generating a dynamic smart contract via a dynamic smart contract engine, wherein the dynamic smart contract is configured to manage validation and claim processing of the eco-crypto token.

7. The process of claim 1, wherein homomorphic encryption of an eco-crypto ID of the customer allows secure processing of the customer data.

8. The process of claim 1, further comprising the step of using the responsible AI module to monitor and ensure resource-efficient eco-crypto token generation and compliance with ethical standards, thereby minimizing unnecessary energy consumption.

9. The process of claim 1, further comprising verifying a customer eco-token balance prior to initiating the transaction or service, and ensuring the customer has sufficient eco-crypto tokens to complete the transaction.

10. The process of claim 1, wherein the eco-token is configured for use with another cryptocurrency or another cryptocurrency platform.

11. The process of claim 1, wherein the knowledge graph is trained continuously using a Hypergraph Neural Network (HGNN) framework to adapt to new energy-saving data, enabling dynamic and accurate allocation of carbon credits.

12. The process of claim 1, wherein the generated eco-crypto token reflects a customer contribution to reducing carbon emissions.

13. The process of claim 1, wherein the transaction is a purchase of an eco-friendly product.

14. The process of claim 1, wherein the service is designing, developing, testing, updating, or maintaining software.

15. A process of purchasing eco-friendly products using an eco-friendly cryptocurrency-based system comprising:
onboarding a customer on a platform that supports eco-friendly product purchases;
allowing the customer to purchase eco-friendly products using a cryptocurrency token specific to the platform;
completing a cryptocurrency transaction for the purchased eco-friendly product;
providing, via the platform that supports eco-friendly product purchases, the purchased product to the customer;
associating the purchase with an amount of carbon savings linked to the eco-friendly product purchased;
adding a corresponding reward value to a reward ledger based on a cryptocurrency value used for purchasing carbon-saving products; and
updating the reward ledger.

16. The process of claim 15, further comprising:
receiving identity data for a customer;
verifying the customer identity through a Know Your Customer (KYC) verification;
wherein the KYC process checks the customer data for compliance with identity verification regulations;
onboarding the customer after successful KYC verification, or returning the customer to a verification process if the KYC verification is unsuccessful;
generating an eco-crypto token for the customer via an eco-crypto token generator upon successful onboarding of the customer;
recording the generated eco-crypto token in a carbon crypto rewards ledger, wherein the carbon crypto rewards ledger maintains a record of customer eco-crypto tokens and associated rewards;
completing the customer onboarding process, wherein the customer is successfully integrated into the platform after the eco-crypto token generation and logging processes.

17. The process of claim 15, wherein the eco-friendly products available for purchase are filtered based on a predefined sustainability criteria, such as carbon footprint reduction, biodegradability, or renewable resource usage.

18. The process of claim 17, wherein a calculated carbon savings score for each eco-friendly product based on its lifecycle carbon impact is displayed to the customer.

19. The process of claim 18, further comprising generating a dynamic smart contract comprising instructions for validation and claiming of the customer associated rewards.

20. A non-transitory machine-readable medium storing instructions for generating synthetic eco-crypto tokens for carbon credits that, when executed by one or more processors, cause the one or more processors to perform steps comprising:
identifying an energy-efficient transaction or an energy-efficient service by collecting relevant data using a data-centric artificial intelligence (AI) module;
analyzing an energy savings associated with each product or service and calculating corresponding carbon credits;
storing information on energy savings and carbon credits in a knowledge graph, wherein the knowledge graph is trained using a hypergraph neural network to encode high-order data correlations;
generating an eco-crypto token based on analyzed data provided by the data-centric AI module and knowledge graph;
onboarding a customer onto an eco-crypto rewards platform and generating a unique eco-crypto token based on customer-specific data and a timestamp;
collecting energy-saving data using the data-centric AI module and training the knowledge graph to reflect energy efficiency metrics;
encrypting the eco-crypto token with homomorphic encryption to ensure secure transaction processing;
validating the transaction using a responsible AI module based on data from the knowledge graph;
providing, via a platform that supports eco-friendly product or service purchases, the product or service to the customer; and
recording the generated eco-crypto token in a rewards ledger.
